(19) United States
(12) Patent Application Publication
(10) Pub. No.: US 2005/0215748 A1
(43) Pub. Date: Sep. 29, 2005

(54) Surgical adhesive formulations and methods of preparation

(76) Inventor: Michael T. Milbocker, Holiston, MA (US)

Correspondence Address: Francis H Kirkpatrick;Promethean Surgical Devices, Suite G, 3 Gil St., Woburn, MA, 01801-1720, US

(21) Appl. No.: 11/092,396

(22) Filed: Mar. 29, 2005

Related U.S. Application Data
(60) Provisional application No. 60/557,314, filed on Mar. 29, 2004.

(51) Int. Cl. C08G 18/00

(52) U.S. Cl. 528/44

(57) ABSTRACT

This application describes specific ratios of raw ingredients and methods of combining and reacting those ingredients to obtain polyurethane prepolymers optimized for the special purpose of forming bonds to living tissue, or of bulking or sealing it. Preferred prepolymers are based on polyalkylene oxides, particular copolymers of ethylene oxide and propylene oxide. Important method steps are rigorous drying and deionization, and rigorous control of temperature during synthesis and use.

### PRIORITY

This application claims the benefit of the priority of U.S. provisional application 60/557,314, filed Mar. 29, 2004.

### TECHNICAL FIELD

Various formulations and methods of preparing isocyanate-terminated polyols are described. These formulations and methods yield compositions uniquely suited as surgical materials such as adhesives, sealants and bulking agents since their structure promotes tissue bonding before bulk polymerization.

### BACKGROUND

The following U.S. patents describe the background upon which the invention is an improvement: U.S. Pat. No. 3,939,123, Matthews, et al.; U.S. Pat. No. 4,118,354, Harada, et al.; U.S. Pat. No. 4,731,410, Bueltjer, et al.; U.S. Pat. No. 4,743,632, Marinovic; U.S. Pat. No. 4,804,691, English, et al.; U.S. Pat. No. 4,829,099, Fuller, et al.; U.S. Pat. No. 4,898,919, Ueda, et al.; U.S. Pat. No. 4,994,542, Matsuda, et al.; U.S. Pat. No. 5,173,301, Itoh, et al.; U.S. Pat. No. 5,266,608, Katz, et al.; U.S. Pat. No. 5,461,124, Ritter, et al.; U.S. Pat. No. 5,508,111, Schumaker; U.S. Pat. No. 5,866,632, Hashimoto, et al.; U.S. Pat. No. 5,922,809, Bhat, et al.; U.S. Pat. No. 5,925,781, Pantone, et al.; U.S. Pat. No. 6,162,863, Ramalingam; U.S. Pat. No. 6,265,016, Hostettler, et al.; U.S. Pat. No. 6,296,607, Milbocker; U.S. Pat. No. 6,503,997, Saito, et al.; U.S. Pat. No. 6,524,327, Spacek; U.S. Pat. No. 6,528,577, Isozaki, et al.; U.S. Pat. No. 6,562,932, Markusch, et al.; and U.S. Pat. No. 6,610,779, Blum, et al.

This application describes specific ratios of raw ingredients and methods of combining and reacting those ingredients to obtain polyurethane prepolymers optimized to the special purpose of forming bonds to living tissue. A tissue bond is the result of chemical bonding, mechanical bonding, and attractive forces between molecules.

Chemical bonds occur when the functional NCO groups in the prepolymer attach to amino groups or to other nucleophilic groups (such as hydroxyl and sulfhydryl groups) present on the tissue surfaces of the body, for instance on cell surfaces or in extra-cellular matrix. Mechanical bonds occur when the liquid prepolymer infiltrates small-scale structures at the tissue surface and solidifies within these structures. In addition, attractive intermolecular forces between tissue and prepolymer can affect chemical and mechanical bonding as well as providing additional electrostatic and electrodynamic attractive forces. Intermolecular forces include dipole forces, Van der Waals forces, and hydrogen bonding. Van der Waals forces are relatively weak forces, but dominate the attraction between nonpolar materials.

These Van der Waals forces do not form tissue bonds directly but can play a role in the polymerization dynamics of the prepolymer, and thus indirectly affect tissue bonding. Tissue is mostly polar, and therefore tissue bonding will be more affected by dipole forces and most affected by the formation of hydrogen bonds. Hydrogen bonding is a special case of dipole interaction where the molecules of the adhesive and the molecules of the tissue share electrons. For example, polyurethanes contain electronegative sites with quasi-stable pairs of valence electrons, such as nitrogen and oxygen atoms. These valence electrons can interact with hydrogen atoms in the tissue, significantly increasing bond strength. This can be viewed as a virtual crosslink to tissue.

In all aspects of tissue bonding, the bond strength is improved when the adhesive aggressively wets the tissue surface. This can be seen macroscopically by observing the tendency of the adhesive to spread across the tissue surface. This “spreading” is due to the affinity of the prepolymer molecules and the tissue molecules to come into close contact at a molecular level. Since the electromagnetically mediated forces fall off rapidly with distance, even slight changes in the chemical structure can have clinically significant impact on the performance of a tissue adhesive. The wettability of an adhesive is the sum effect of a competition between the strength of intermolecular attraction within the adhesive, the intermolecular attraction of molecules within the tissue and the intermolecular attraction between molecules in the adhesive and molecules in the tissue. Therefore, it is useful to provide in an adhesive, a component that has a special affinity for altering intermolecular attraction by treating the tissue surface.

Either the adhesive in its entirety or a component of it must possess a surface energy that is compatible with the surface energy of the tissue surface. To obtain wetting, it is desirable that the surface energy of the tissue be the same as or greater than at least one component of the adhesive. Polar materials tend to have higher surface energy than non-polar. Since tissue typically has regions of polar surfaces and regions of non-polar surfaces (such as lipids), it is desirable to have at least one non-polar component in the adhesive to obtain optimal non-covalent bonding. In turn, the non-covalent bonding positions the covalent bonding groups of the adhesive in proximity to the tissue. For example, an adhesive comprised entirely of isocyanate capped polyethylene oxide does not bond well to tissue. On the other hand, an isocyanate capped polypropylene oxide does bond to tissue. However, polypropylene oxide reacts slowly with isocyanates in the absence of a catalyst. Therefore, by using a copolymer of polyethylene and polypropylene oxides one can end cap the copolymer with an isocyanate without the need for a catalyst.

Bond failure can occur within the adhesive or at the interface between the adhesive and tissue or prosthetic. When the failure occurs at the interface between adhesive and tissue or between adhesive and a prosthetic it is called adhesive failure. When the failure occurs within the adhesive it is called cohesive failure. Tissue adhesives can be engineered to fail in either mode. When the application calls for thick layers of adhesive, such that the cured adhesive provides structural support as well as bonding then the preferred failure mode is cohesive failure. In other words, since it is known a priori that a thick layer of adhesive will be used, the chemistry can be adjusted to favor high adhesive failure since the liberal use of the adhesive in the application will offset the effects of a lower cohesive failure point.

Alternatively, when the adhesive is to be used to attach a prosthetic to a tissue surface the preferred failure mode is adhesive failure. Even when the adhesive and cohesive failure points are optimized to the intended use of the adhesive, other factors need to be considered in order to obtain the greatest clinical efficacy. Adhesive failure is a surface effect and failure is expressed in units of force per unit area. Cohesive failure is a volume effect and failure is expressed in units of force per unit volume. Thus increasing the thickness of an adhesive layer increases the cohesive failure point while leaving unaffected the adhesive failure point. But since both are spatially dependent effects, the efficiency with which an adhesive dissipates, distributes and absorbs stresses determines to some extent its failure points.

There are three basic components to a polyurethane based adhesive: 1) isocyanates, 2) polyols, and 3) chain extenders. It is desirable that a tissue adhesive be one-part, as opposed to requiring the mixture of solutions when applying it to tissue. An adhesive containing multiple parts runs the risk that at least some of one of the parts may dissipate within the tissue before reacting with the other parts, resulting in lower bond strength and potential toxic consequences. Also, measuring and mixing must be more accurate and thorough if the adhesive is multi-part.

The isocyanate component could be considered a tissue adhesive on its own. However, isocyanates are generally small molecules and can have associated toxic effects due to their small size, which allows penetration to other areas, and to their high potential tissue reactivity. However, when these isocyanates are reacted with polyols of molecular weight greater than about 2000, the toxicity of the isocyanate capped polyol is several orders of magnitude lower than the toxicity of the isocyanate monomer.

Crosslinked structures of low molecular weight polyisocyanates are typically not long enough to form the random, intertwined coils that give adhesives their strength. These low molecular weight isocyanates tend to form neatly arranged structures that are tightly packed, creating a brittle crystalline state. The large molecular weight polyol attachment is required to achieve a polyurethane polymer with elastomeric properties, which preferably is at least partially in a two-phase state, where the hard segments separate to form discrete domains in a matrix of soft segments.

Similarly, adducts of diisocyanate with trimethylolpropane and other triols of low molecular weight are not ideal as tissue adhesives. For these structures to form cohesive volumes a portion of the NCO ends must be converted to amino groups so that they may chain extend by crosslinking with other NCO groups. This can be accomplished by reaction with water at the tissue site. The converted groups then act as hard segments in the formation of the cured adhesive. Such formulations are typically too rigid and brittle to act as effective tissue adhesives.

Another option is to form an adduct of diisocyanate and high molecular weight polyol and chain extend it with a separate chain extender. Alkanolamines and diamines serve as chain extenders, but the reaction of isocyanate terminated prepolymers with amines is too fast for medical applications. There is also the problem of obtaining adequate mix before polymerization. In this less preferred embodiment, a sterically hindered amine may be required to achieve proper mixing. More importantly, the presence of an amine causes chain extension before tissue bonds can be established resulting in a rapidly cured adhesive with minimal tissue bond strength. Hence, an improved isocyanate material is needed to form polyurethane medical adhesives and sealants.

### SUMMARY OF THE INVENTION

Therefore, it is desirable to create a tissue adhesive of predominately one species, where the species has the general structure of a polymer terminated with isocyanate, some or all of which may be trifunctionalized by the addition of a triol, or by providing the polymer as a trifunctional structure of moderate molecular weight which is polyisocyanate capped. Moreover, the tissue adhesive desirably acts as its own chain extender, with chain extension occurring when a portion of its NCO groups are converted to amines when added to a wet tissue surface. These form urea and biuret linkages, building molecular weight, strength, and adhesive properties.

As mentioned previously, it is found in practice that it is desirable to also have a small fraction of low molecular weight isocyanate in a tissue adhesive, in addition to the isocyanate-capped polymers. The low molecular weight (MW) isocyanate may act as a primer or adhesion promoter. The low MW material can be added at the end of a synthesis, or a portion can remain as a result of carefully controlling the synthesis process.

Polyfunctional low MW polyisocyanates are effective primers, for example, 4,4′,4″-triphenylmethane triisocyanate, adducts of TDI or MDI with trimethylol propane, polymeric MDI, and trimers of TDI. While trifunctional or higher functional primers are highly effective and preferred, low molecular weight diisocyanates are also effective as primers or promoters.

In practice, terminating a polyol with an isocyanate must be done with an excess of free isocyanate if all the hydroxyl groups are to be terminated. Termination of all the hydroxyl groups is essential to long shelf-life and adequate adhesive cure strength. Polyurethane tissue adhesives that are not completely end capped may have compromised adhesive strength, and will be less stable during storage. This is because the open hydroxyl groups on the polyol will eventually react with the isocyanate-terminated ends of other terminated polyols, and chain extend the prepolymer before its application to tissue.

It is therefore an object of the present invention to provide one-part polyurethane prepolymer formulations that are uniquely suited to use as a tissue adhesive. These prepolymer formulations embody several characteristics important for tissue bonding. These include enhanced hydrogen bonding, tissue wettability, optimized adhesive and cohesive failure modes, and tissue-matched modulus. Chemically, the improved tissue adhesives contain a very low level of allophanate, biuret and isocyanate linkages, in order to, optimized shelf-life, and strength in use. In one aspect, the stability of the preparations is enhanced without use of catalysts, so that the final product is essentially catalyst-free. Other aspects of the invention will be described below.

### DETAILED DESCRIPTION OF THE INVENTION

Conditions will be described below which allow the optimization of the degree of polymerization of the tissue adhesives of the invention under the somewhat unfavorable conditions found in polymerizations occurring at physiological temperatures and in the presence of variable concentrations of water and other species reactive with isocyanates. We will show that critical variables for obtaining consistent bonding of sufficient adhesive strength include careful attention to temperatures during synthesis, and to the order of addition of ingredients during synthesis.

DEFINITIONS: A “free” polyisocyanate is synonymous with a “low MW” polyisocyanate, and is exemplified by materials such as TDI (toluene diisocyanate) and IPDI (isophorone diisocyanate.) A medium molecular weight polymer is one in the general range of about 500 D to about 10,000 d, with no sharp cutoff being intended unless stated.

Single component surgical adhesives having highly desirable clinical characteristics have been developed, and methods of making such surgical adhesives are disclosed. Single component adhesives are preferred in clinical use in order to avoid preparation requirements at the time of surgery and treatment, which can be a distraction and inconvenience to surgical personnel at a time when full concentration on the patient and surgery are required. In addition, the greater the preparation steps required at the time of surgery the greater the probability that an error in preparation can occur, delaying or impeding surgery and extending the time the patient is subject to anesthesia, increasing operating time and costs, etc.

Since the adhesive strength is proportional to the number of NCO groups per unit volume of prepolymer available for reaction with tissue, not terminating all the hydroxyl groups falls short of an optimally bonding prepolymer. Allowing chain extension in the prepolymer post-synthesis further reduces the prepolymer bonding potential by consuming additional NCO groups in the chain extension.

To obtain minimal mechanical properties, it is stated by some authors that the degree of polymerization (DP) should be at least 50. DP is defined as
DP=1/(1−p) where p=(Nₒ−N)/Nₒ
where Nₒ is the initial number of molecules, N is the remaining number of molecules and p is the conversion (fractional amount converted.)

Polyols which are not fully end-capped will either not participate in chain extension or terminate a chain. Full conversion, or p=1, occurs when all the initial molecules create one inter-connected molecule. Incomplete end-capping obstructs this process. Using the above standard (DP=50) when the monomers are effectively difunctional, we see that p=0.98. In that situation, when as few as 2% of the available hydroxyls are not end-capped, the adhesive will fail to form a cohesive mass when polymerized.

Thus, it is important that a synthesis procedure be devised where a slight excess of isocyanate serves both to fully end-cap the hydroxyls of the polyol as well as leave a promoter fraction in the form of either free diisocyanate or end-capped low molecular weight triol.

The starting low MW isocyanates to be used are of two or greater functionality. Preferably, the isocyanates are of functionality 2 or 3. Most preferably the starting isocyanates are di-functional. The reaction rate for low molecular weight diisocyanates and triisocyanates is faster than the reaction rate for high molecular weight NCO terminated polyols. When the isocyanates are low molecular weight, and when these species are included in a one-part adhesive they effectively act to prime the tissue surface before chain extension occurs. The reason for a tissue priming effect is two-fold. First, their size contributes to their mobility and hence reactivity. Second, for many diisocyanates, including IPDI (isophorone diisocyanate) and TDI (toluene diisocyanate), one of the NCO groups is more reactive than the other. For IPDI the difference in reactivity between one NCO group and the other is between 5 and 12 fold depending on the group with which it is reacting. During the formation of adduct of isocyanate and polyol the more active NCO group reacts with the polyol, leaving the less reactive end exposed.

It is important to recognize that from room temperature up to 50 deg. C. isocyanates react with hydroxyl groups to produce polyurethanes, with few side reactions. However, above 50 deg. C., and at temperatures up to 150 deg. C., other reactions produce allophanate, biuret and isocyanurate linkages.

These reactions all contribute to short shelf life by forming cross links in the prepolymer. It is best not to create them, but if in-situ reaction time is a concern and needs to be modified, then a quick heating of the final prepolymer above 150 deg. C. and a rapid cooling below 50 deg. C. should significantly reduce the formation of such cross-links and their related effects. Temperatures above 150 deg C. open the cross-links, and rapid cooling reduces their reformation.

In the formation of allophanate, the urethane group donates an active hydrogen which reacts with a free isocyanate forming a branch point. High temperature can also result in polyurea formation, in which the urea group supplies the active hydrogens to react with the isocyanate, forming a branch point biuret. Also at elevated temperatures isocyanate can form a cyclic trimer. Consumption of NCO groups by these side reactions can result in some OH groups on the diols being left uncapped. These OH groups can later react, albeit very slowly, with the functional ends of the isocyanate terminated polyols, increasing viscosity and ultimately curing the prepolymer while in storage. In addition, the presence of allophanate in the prepolymer decreases tensile strength and tear strength when the prepolymer is polymerized.

In the reactions of diisocyanates, the reactivity of the second isocyanate often decreases significantly after the first has been reacted. This is due to a decrease in effect of the electron withdrawing substituents on the isocyanate molecule decreasing the partial positive charge on the isocyanate carbon and moves the negative charge closer to the site of reaction. This makes the transfer of the electron from the donor substance to the carbon harder, thus causing a slower reaction. Furthermore, the reactivity of the two isocyanate groups may not be the same to begin with due to the presence of bulky groups creating steric hindrance.

Synthesis

In one synthesis route, the preferred single-component adhesives are made of diols end-capped with isocyanate, with the resulting diisocyanate material being tri-functionalized to increase chain length by reacting the end-capped diol with a triol, typically a low molecular weight triol. Alternatively, a polymeric trimer can be prepared by other synthesis methods, and can then be capped with small diisocyanates, alone or along with a polymeric diol. In the preferred methods, a diol (if used) and a triol are separately deionized and dried prior to end-capping and final polymerization.

A deionization procedure that may be used on a polyol, including a diol, a triol or a higher polyol, is disclosed. In an inert atmosphere, such as a nitrogen or argon atmosphere, the diol or triol is mixed with an ion exchange resin at a slightly elevated temperature, such as 30 to 40° C., more preferably 34 to 38° C. and most preferably 35 to 37° C., and then incubated for several hours. The solution is drawn under vacuum through a filter pre-treated with additional ion exchange resin and heated to an elevated temperature above 100° C. and more preferably to about 110 to 130° C. and most preferably to about 120° C. for several hours while the inert gas atmosphere is regularly refreshed. The deionized material may be stored in a sealed glass container purged with inert gas. In this manner a polyol may be deionized as a preparatory step to further reaction.

The deionized polyol also should be dried. In a first drying step the polyol is placed in a vessel and heated above 100° C. and more preferably to about 120° C. for 4 to 12 hours and preferably about 8 hours while a flow of inert gas passes through the vessel. The dried deionized polyol may be stored in a glass container under inert gas. The goal is to have a water content below about 80 ppm (by weight).

Shortly before further processing of the deionized, dried polyol, it is optional and preferable to conduct a second drying process, particularly if the residual moisture is high, and/or when the polyol is polymeric. In the second drying process, an isocyanate material having a melting temperature lower than the melting point of the polyol, and below about 30 deg. C., is selected. This is the same isocyanate material that will be used in further processing to end-cap the polyol. The isocyanate material will typically be dry because of reaction of its isocyanate groups with any water in the preparation. The isocyanate may be purified by distillation or other conventional measures if required.

Next, the diol and isocyanate are brought to a temperature slightly above the melting point of the diol, and the isocyanate is added to the diol. The temperature of the mixture is maintained and the solution is mixed for 1 to 24 hours. Then the mixture is cooled to a few degrees above the melting temperature of the isocyanate. This will precipitate the polyol from the isocyanate. A relatively large amount of isocyanate should be used in this process, preferably an amount many times greater than the amount of the same isocyanate to be used in end-capping the diol, such as about 10 times the amount of isocyanate to be used in end-capping the diol. After the drying procedure, the excess isocyanate is drawn off and the diol precipitate is saved for further processing, being stored at 10 deg. C. or below in a sealed container.

Next, the diol is covalently end-capped with the isocyanate. Since the reaction between a hydroxyl group and an isocyanate liberates 25 kcal/mole, and since high temperature can promote side reactions, it is important during synthesis to either slowly add the polyol to the isocyanate or to actively cool the mixture. (When the second drying step has been used, active cooling and slow warm-up are the control processes.) The end-capping process is controlled at a relatively low temperature, for example about 30-50 deg. C., under an inert atmosphere to drive the reaction in controlled manner to assure uniform distribution of the isocyanate with the diol and to create a uniformly terminated diol. The end-capped diol is then ready to be tri-functionalized to create the prepolymer adhesive. It is either used immediately, or stored in a dry and cold environment.

The end-capped diol is next reacted with a triol, typically a low molecular weight under an inert atmosphere, preferably argon, to create chain extension to increase the length and structure of the polyol. As in the end-capping step, the temperature is controlled and the reaction is kept dry. The resulting prepolymer is a single component prepolymer useful alone or admixed with water (saline) or other ingredients as a surgical adhesive, sealant space filling material (e.g., spinal disc nucleus supplement or replacement or bulking material).

Alternatively, a polymeric triol is supplied, and is deionized, dried, and end capped with isocyanate as described above for diol. This route creates a product that is functionally similar to the product of the reaction of the end capped polymeric diol with low MW triol described above.

For making the functionalized prepolymer, low MW diisocyanates are preferred (also known as “free” diisocyanates). Aromatic isocyanates are preferred for fast curing compositions, and the most preferred isocyanate material is toluene diisocyanate (TDI). In some applications, slower curing compositions are preferred. Aliphatic diisocyanates are preferred in such uses, for example IDPI (isophorone diisocyanate). These preferred free isocyanates are widely available and have been used in the examples below. However, there are a large number of diisocyanates available, some of which are listed in earlier patents and publications from this group (e.g. U.S. Pat. Nos. 6,528,577 and 6,503,997), and these may be used to obtain different polymerization rates, different melting temperatures, lower prices, or other conventional variations.

The polymeric polyol component needs to be sufficiently hydrophilic to be soluble in water, and sufficiently hydrophobic to interact with itself non-covalently to promote strength in the polymerized adhesive. A preferred class of polyols is the polyether polyols, or poly(alkylene) oxides. These are widely available. PEO (polyethylene oxide) and PPO (polypropylene oxide) and their copolymers (P(EO:PO)) are well known. A preferred diol is a polyethylene glycol/polypropylene glycol copolymer having EO:PO numerical ratios in the range from about 75:25 to about 25:75, most preferably about 70 to 75% EO subunits and 25 to 20% PO subunits. Inclusion of some polybutylene oxide or trimethylene oxide monomer is possible as long as the solubility is not compromised. Inclusion of degradable groups is also possible, as described, for example, in Roby (U.S. 2003032734) and Milbocker (U.S. 20040068078).

When a low molecular weight triol is used, the preferred triol is trimethylol propane (TMP). A number of low MW triols and tetrols are known and are useful for making branched isocyanate-capped polymers from isocyanate-capped polymeric diols. The polymeric glycol and the low MW triol are deionized and dried as described above, the glycol is end-capped with diisocyanate, and the end-capped glycol is then reacted with the triol to create the desired prepolymer useful for mammalian and human clinical application as an adhesive or sealant, as preferred.

Alternatively, as noted above, a polymeric triol or higher polyol, or mixture, is obtained as starting material, and is end capped with free diisocyanate. For example, trimeric and tetrameric polyalkylene oxides can be made by starting with a low MW triol or tetrol, and are commercially available. These, and mixtures of these with polymeric diols, can be deionized, dried, and end capped in a single production step, allowing the finished polymeric polyisocyanate to be packaged in sealed containers and stored without intermediate or final purification. If moisture can be reduced below about 100 ppm by weight, a self life of one to two years is possible. With lower water levels, longer storage life is possible.

The MW (molecular weight) of the finished isocyanate-capped polyol is not a critical parameter, but is constrained by practical considerations. The desired end product is preferably a liquid at room temperature, and has a low enough viscosity to be easily delivered to the site of use through a selected delivery system, such as a syringe and needle, or a cannula, or a catheter. The crosslink density must be high enough to give the required mechanical modulus and toughness. While these criteria favor lower molecular weights, higher MW can improve strength. A preferred MW for the final product is at least about 1000 D and preferably in the range of about 3000 to about 40,000 D, more typically in the range of about 5000 to about 20,000 D. Preferred molecular weights for trimers are in the range of about 3000 to about 8000 D, and for medium MW diols of about 800 to about 3000 D. The free diisocyanates are typically about 150-300 D, and LMW triols are similar, e.g. trimethylol propane is 135 D.

The viscosity of the finished preparation is not critical as long as it is below an upper limit. The upper limit is about 150,000 centipoise at room temperature (ca. 20 deg. C.). Above this level, the liquid polyol is too viscous to be dispensed by hand operation under typical in-vivo conditions, such as dispensing without dilution, and using only reasonable hand pressure, from a syringe through a 1/2 inch (12.7 mm) long 20 gauge hypodermic needle (which can serve as a simple test of suitability.) Preferably, the viscosity is below about 130,000 centipoise, more preferably below 110,000 centipoise, and most preferably below about 90,000 centipoises.

The storage interval during which the finished, packaged, isocyanate-terminated prepolymer with free isocyanate prepolymer remains below the viscosity limit is at least about 6 months, after sterilization and on storage at room temperature; more preferably at least about a year; and still more preferably about two years or more.

To obtain materials having these extended shelf lives, the water content must be kept low, for example below about 100 ppm by weight, and preferably below 80 ppm by weight. In addition, the degree of branching and chain extension must be controlled. The idealized profile of Example 2 below would be preferred; the manufacturable and functional material of Example 1, with significant content of higher-functionality isocyanate-capped polymers, is obtainable with the carefully dried materials of the invention.

Polymerization

Polymerization times can be adjusted by selection of various components of the polymerizing material. Principally, the material comprises at least a polyisocyanate-capped polymeric polyol and free polyisocyanate. The capped polymeric polyol is multifunctional, and typically trifunctional. The polyol may be any of various biocompatible substances, preferably polyethylene oxide (also called polyethylene glycol), polypropylene oxide, and copolymers of these. The free polyisocyanate is typically difunctional. Fast reacting formulations use an aromatic diisocyanate such as toluene diisocyanate. Slow reacting formulations use an aliphatic diisocyanate such as isophorone diisocyanate. Alternatively, the polymerization time can be adjusted by selection of appropriate molecular weight polyols. The reaction rate is controlled in part by viscosity, which may actually decrease with MW in some polyalkylene oxide solutions in water, and which therefore is best determined experimentally.

The cure times achieved using the approaches described above depend, in part, on controlling the rate of water diffusion into the prepolymer, the rate of isocyanate to amine conversion, and the activity of the isocyanate functionalized ends. There are various additions to the prepolymer that can be made at the time of application to speed prepolymer curing. For example, when water is added to the prepolymer just before application, the cure time dependence on water diffusion is reduced. Generally, addition of water in volumetric rations of approximately 50% maximally reduces cure time. When additional water is added, such as 80 or more % by volume, the cure time increases from its fastest mixed cure time because the polymer density decreases. Similarly, when using higher concentrations of prepolymer, such at 80% or more by volume, the cure time increases from its fastest cure time because the water availability decreases. However, all mixtures with water, from 1% up to about 95% by volume, cure faster than application of prepolymer placed directly on tissue. It is sometimes desirable to lightly irrigate the location with water after pure prepolymer has been applied to tissue, for optimal curing.

The first reaction of water with the prepolymer is to convert some of the active isocyanate ends on the isocyanate capped polyol and some of the active isocyanate ends on the free isocyanate, comprising the prepolymer, to amine groups. Amine groups cause rapid chain extension. Therefore, reduced cure times can be achieved by substituting some or all of the water admixture with aqueous amines.

Synthesis Details

The extent to which tissue bonding can be established is determined in part by the way the prepolymer is synthesized. The reactivity of the isocyanate groups remaining after synthesis, the formation of amines and side reactions that act as chain extending agents during synthesis, hydrophilicity of the polymer backbone, concentration and ratios of raw ingredients as they are reacted, and the temperature and mechanical conditions such as rate of mixing all play a role in determining whether a common set of ingredients is an effective tissue adhesive or a self-polymerizing mass with relatively little adherence to tissue.

Preparation of intermediate products plays an important role in producing an effective tissue adhesive. Generally speaking, in accordance with the preferred method described in outline above, diols and triols are first de-ionized and dried, the de-ionized diol is end-capped with isocyanate, and the isocyanate end-capped diol is trifunctionalized by reaction with the de-ionized, dried triol. Each of these steps is described below.

De-Ionization Procedure for Diols and Triols

The materials required are a mixed bed ion exchange resin such as Dowex mixed bed ion exchange resin (for example 50W-X8 or HCR-W) or other commercial mixed bed resin system, filter paper such as Whatman #1 filter paper, a Buchner funnel, a vacuum pump, and a reactor vessel.

Select the Buchner funnel to fit inside of a reactor chamber so that the funnel can be charged with diol in an inert atmosphere. Preferably, the discharge end of the funnel is sealed to a receiving chamber to which a vacuum can be applied.

To deionize approximately 300 ml of diol the following steps are required.
1. Agitate for 1 hour at room temperature 300 ml of diol.
2. In an inert atmosphere, preferably an argon atmosphere, mix 300 ml of agitated diol with 10 grams of ion exchange resin at 37° C. Mix mixture under heat at about 37° C. for 4 hours. This will be called Solution A.
3. Place the filter paper in the funnel setup and wet the surface of the paper with a small amount of Solution A. Cover the treated filter paper with an additional 10 grams of fresh (unexposed) ion exchange resin.
4. Start the vacuum pump on the filter setup and charge the funnel with Solution A.
5. Blanket the charge with argon. The setup should be such that argon is not drawn by the vacuum pump.
6. Collect the filtered material and place in a reactor under argon and heat at 120° F. for 12 hours. The vessel should be refreshed with new argon at a rate of at least 1 reactor volume per hour.
7. Cool the above solution and store in an argon purged glass container with Teflon sealed lid.

After the storage bottle has cooled to room temperature store chilled at 4° C. for a maximum of 6 weeks.

Failure to do this may result in the formation of HCO₃⁻.

The result is a diol substantially free of the following contaminants:

| | | | | | | | | |
|---|---|---|---|---|---|---|---|---|
| NA+ | NH4+ | K+ | Ca++ | Mg++ | Fe++ | Fe+++ | Mn++ | Al+++ |

| | | | | | | | |
|---|---|---|---|---|---|---|---|
| Cl− | SO4−− | HPO4−− | HCO3− | SiO2 | H3BO3 | NO3− | HS− |

(“Substantially free of” in this context means “present in low enough level to meet regulatory requirements”, for example as required by the U.S. Food and Drug Administration (FDA), or an equivalent or similar agency in the US or another country, for use in the treatment of humans or animals.) The foregoing steps are also used to de-ionize a triol to be used in the process to make the surgical compound.
Drying Procedure for Diols and Triols (Polyols)

Take deionized diol (or. equivalently, another type of polyol) and place in a sealable vessel. The vessel consists of a vacuum port, an argon delivery port, an exit port, and a heating mantle. The exit port is to be connected to a receiving vessel with a pressure relief valve.

The steps are:
1. Flush the system with argon.
2. Close the exit port.
3. Place deionized diol in vessel.
4. Run argon over the diol and open vacuum port and run vacuum such that the net result is an argon atmosphere in the vessel at approximately 7 psi below ambient.
5. Heat the diol to 120° C. for 8 hrs.
6. Close vacuum port and open exit port. Allow flowing argon to drive the dried diol into the receiving vessel.
7. Store the diol under argon.
   Second Drying Procedure for Polyols

This procedure is to be used immediately prior to isocyanate capping of a diol, triol or other polyol. When diols are terminated they are later added to triols to trifunctionalize them. When triols or other higher polyols are terminated they are optionally later added to diols to increase their molecular weight, or are of high enough molecular weight to be used alone as an adhesive, bulking agent, and so on.

This procedure uses isocyanate to dry a polyol, and can be used in addition to a heat-drying step. The isocyanate to be used should be the same isocyanate to be used in the isocyanate capping procedure. The melting temperature of the isocyanate and of its amine (after reaction with water) must be lower than the melting temperature of the polyol.

The procedure consists in cooling a known quantity of polyol to a temperature that is slightly above its melting point and cooling separately a quantity of isocyanate to the same temperature. The quantity of isocyanate should be in significant excess, for example about 10 times, of the amount to be used in the isocyanate capping procedure.

The isocyanate is to be added to the diol and the temperature maintained and the solution mixed for 1 to 24 hours, depending on the type of isocyanate used. After the mixing cycle is complete the mixture should be slowly chilled to a few degrees above the melting point of the isocyanate while still being mixed. The polyol will then precipitate out of solution, the isocyanate fraction should be clear. Once the polyol is completely separated from the isocyanate, 90% of the isocyanate should be drawn off the mixture. As a check, the NCO content of the retrieved isocyanate can be measured to ensure that very little of the polyol was removed. Monitoring the pH can also provide a quantitative measure of how much water was retrieved, since water converts isocyanate to a base amine.

The prepared solution is now ready for end capping. As discussed, the drying procedure also could be used to prepare triol or other polyol for use in making the surgical adhesive.

Basic Prepolymer Manufacturing Procedure

The prepolymer manufacturing procedure is comprised of two steps: 1) end capping a deionized, dried diol with isocyanate and 2) reacting the terminated diol with a deionized, dried triol to obtain a isocyanate terminated triol.

The addition of isocyanate to deionized dried diol at room temperature results in an unstable exothermic reaction. It is advantageous to keep the reaction temperature below 50° C. while capping the hydroxyl groups on the diol with diisocyanate. The reason for this is to take advantage of the reduction in reactivity of one of the NCO groups that occurs after the other group has combined with an OH group on a diol. Since the latter's reactivity is diminished, it is disadvantageous to drive this group to react with another hydroxyl group by reacting at an elevated temperature. To do so results in chain extension and an increase in viscosity and mean molecular weight of the solution. Additionally, because the reaction is conducted during a condition of excess free isocyanate, the lower temperature will discourage side reactions such as the formation of biurets, allophanates, and isocyanurates.

Cooling the reaction mixture decreases the rate of combination between the glycol and isocyanate. Because the rate is so fast, slowing the rate is preferred in order to allow uniform distribution of the isocyanate in the glycol. Localized concentrations of isocyanate at elevated temperatures enhance the probability of yielding isocyanurates. Alternatively, the isocyanate can be added gradually, but this is less preferred because microscopically there can be a high concentration of isocyanate reacting at an elevated rate. However, this approach is effective in preventing extreme increases in reaction temperature.

Cooling the reaction mixture is most important in reactions involving aromatic isocyanates since their reactions rates with hydroxyl groups are high. Aliphatic isocyanates are less reactive, and so are somewhat less prone to a runaway reaction. However, providing sufficient cooling as a precaution is preferred in all reactions of this sort.

The reaction of an isocyanate group with a hydroxyl group results in the release of CO2. When the reaction is vigorous, the CO2 is released faster than it can escape from the solution. The resulting CO2 centers cause the reacting solution to be more acidic and introduce inhomogeneity in the solution. It is preferred that the reaction rate be kept low enough to prevent CO2 accumulation in the solution. For some isocyanates this requires actively cooling the solution below room temperature.

Similarly, it is important that the size of the mixing paddles and their rate of spin be sufficiently slow so as not to entrap argon into the mix and sufficiently fast to prevent a steep thermal gradient at the reaction vessel wall. Near the end of the reaction it may be necessary to supply external thermal energy, and conventionally that is done at the vessel wall with an encircling mantle.

Control of the paddles can be continuously revised by collecting data on solution temperature and mixing torque, which then yields solution viscosity which can be used to control the angular velocity of the paddles. Additionally, the paddles may be periodically slowed to promote degassing the solution, and the decision to do this can be controlled by the absorption profile of a beam of light transiting the solution. The beam can be white light or a color that is not absorbed by the solution. For example, in reactions involving TDI the color of the solution yellows over time and blue light as a diagnostic beam should be avoided. The goal is to minimize the contribution to the absorption profile of light scattering due to scattering off gas bubbles. For this reason the light detector should be collimated to avoid collection of side scattered light.

It is beneficial to conduct the reaction under vacuum with a trickle flow of argon to ensure that the prepolymer is degassed and the headspace remains free of water molecules. The vacuum port may be fitted with an actively cooled condenser, which is thermally insulated from the reaction chamber. The condenser should be so oriented that isocyanate condenses and drips back into the reacting mix at low temperature. In this way the condensed and cooled isocyanate is dispersed throughout the reacting mixture before its temperature rises to a point where it is reactive again. To prevent condensation on the walls of the headspace, these walls may be separately heated by a mantle that keeps the temperature at or slightly above the reacting temperature.

In the manufacture of the isocyanate terminated diol the goal is to synthesize a narrow distribution of molecular weights, ideally a single diol with both hydroxyl groups terminated with a diisocyanate. However, from a stability point of view the most important consideration is the elimination of open hydroxyl groups and amine terminals.

In a reaction mixture where all the free isocyanate must combine with the available hydroxyl groups, the balance between the OH and NCO must be carefully calculated and monitored. However, this requires that the ratio of free isocyanate to OH be the minimum required to terminate all the hydroxyl groups. This is not ideal since such a ratio encourages chain extension of the diols and at the same time leaves some isocyanate unreacted. While the unreacted isocyanate will ensure complete termination of the OH and formed amine, every reaction will strike a balance either during the reaction or later on the shelf. It is possible that chains extension will occur and some OH and amines are left unterminated. Such mixtures, while possibly yielding a desirable theoretical NCO content, were found to be unstable upon storage.

One way discovered to ameliorate the instability problem was to create terminated diol and store it for a time to allow the viscosity and % NCO to stabilize. It was found to be beneficial to store supplies of terminated diol with different stabilized % NCOs and blend these on demand when ready to react the diols with triol. Alternatively, prolonged heating in the reactor stabilizes terminated diol, but for some isocyanates and diols, side reactions and changes in the diol occur.

One way to increase storage stability of the final prepolymer is to react the diol with a very large excess of isocyanate and remove the excess isocyanate at the end of the reaction. The excess isocyanate discourages chain extension and ensures that amines and hydroxyls are fully terminated. After reaching a stable NCO content, the mixture is then cooled and passed through a porous solid, the surface of which is coated with anchored blocking agent. Since the NCOs on the free isocyanate are more reactive, a suitable temperature localizes the free isocyanate to the porous solid while leaving the terminated diol in solution. This strategy is particularly effective for diisocyanates where one of the NCOs is significantly more reactive than the other, for example, IPDI. The filtering process can optionally be continued until the % NCO drops to a level corresponding to exactly two isocyanates per single diol.

An adaptation of this approach is to use only enough isocyanate to terminate all the hydroxyl groups on the amount of diol to be used, but charge the reactor with all the isocyanate and add the diol gradually. Using this technique, it was found that most of the reaction is conducted under isocyanate rich conditions, and only the final additions of diol results in competition between chain extension and hydroxyl termination. In batch reactions, this approach can be difficult given that the volume of isocyanate can be as low as 10% of the final volume. A given mix configuration suitable for mixing the isocyanate volume may not be ideal for mixing the total volume. However, using a multiplicity of blades that engage as the solution level rises in the reactor was found to be a practical solution to this problem.

In the diol addition approach, it is necessary to cycle the temperature of the reacting solution so that the temperature is at a minimum when fresh diol is added to the reactor and at a maximum at some point in the cycle where all the hydroxyl groups are expected to be terminated. The minimum typically is 15° C. and the maximum 50° C. The goal is to have no open hydroxyl units remaining in the solution at the beginning of the next diol addition.

The period of the thermal cycle increases as the amount of diol added to the solution increases. The reason for this is the decreasing availability of free isocyanate for termination of additional hydroxyl groups. The termination of a thermal cycle can be controlled automatically by detection of an absence of CO2 bubbles in the solution. Alternatively, in a closed argon circulating system, the concentration of CO2 in the circulating loop can be monitored, and when the CO2 level plateaus the next cooling cycle is begun.

In the case where the isocyanate and diol are charged in their entirety together the reaction is driven through a single thermal cycle. The starting temperature is 15° C. at which temperature the reaction rate of free isocyanate with the hydroxyl groups of polymeric polyols is low. The entire charge of free isocyanate is thoroughly mixed with the polyol preparation at 15° C. Then, the temperature is increased following roughly a schedule such as the following:
15° C. for 1% of the total anticipated reaction time
20° C. for 5%
25° C. for 25%
30° C. until all the CO2 bubbles leave solution
35° C. until all the CO2 bubbles leave solution
40° C. until all the CO2 bubbles leave solution
45° C. until all the CO2 bubbles leave solution
50° C. for 5% of the total reaction time or until all, if any are liberated, of the CO2 bubbles leave solution

This strategy is applicable to all isocyanate/diol systems. When increasing reaction temperature in the range 25° C. to 45° C., care should be taken not to generate an exotherm, which causes the solution to overshoot the target temperature. It is preferable to release the exotherm slowly by gradual increases in temperature rather than actively cooling the solution. For a particular system, this will be determined by a few exploratory experiments at small scale for the particular preparation, optionally using instrumental methods such as calorimetry.

The temperature raising procedure can be controlled through an algorithm, which heats the mantle in response to data collected at the mantle surface and in the solution. Generally the algorithm should not allow the temperature at the mantle surface to be more than 2° C. higher than the solution temperature. The mantle temperature should not increase faster than 0.1° C. per minute. In some cases the exothermic energy released is not a linear function of the solution temperature. This exotherm should be carefully mapped so that increments in mantle temperature reflect this information. In particular, where the exotherm is strongest, increments in mantle temperature are smallest.

During the exothermic phase, the solution may self-heat. In this case the mantle temperature may drop several degrees below the solution temperature because no mantle heating cycle is triggered. The mantle in this instance begins to act as a heat sink to the solution. In systems where this is the case, it is preferable to actively cool the solution, traditionally with an intra-solution cooling coil. In this case, as the mantle cools the sensor at the mantle surface will trigger maintenance heating cycles so that the mantle temperature stays within 2° C. of the solution temperature.

It is preferable to maintain a close association between mantle temperature and solution temperature so that during a ramp up in solution temperature the mantle does not have to undergo a self heating cycle. Such self heating cycles typically overshoot their target temperatures due to the difference in temperature of the internal coils of the mantle and the mantle surface. Typically the thermal mass of the internal coils is sufficient to continue heating the mantle surface beyond a target temperature when the coil temperature is driven high above the mantle surface temperature in an effort to reheat the mantle. This situation is less likely to occur when the heating coils are in good thermal contact with the solution, for example, when the coils are embedded in the reactor walls.

Alternatively, the intra-solution coil may serve as both a thermal drain and source. In this instance, reservoirs of hot and cold circulating liquids should be maintained so that when a reaction exotherm is encountered the system does not have to cool a large thermal mass, i.e., the circulating fluid, in an effort to respond to the exotherm. Ideally, fluids from the hot and cold reservoirs are stepwise added to the circulating fluid so as to avoid large temperature difference between coil and solution. The algorithm may include adjustments of paddle speed to keep the coil temperature and solution temperature within a target range.

Finally, for some reactions it may be preferable to deliver heat energy electrodynamically, either with light, ultrasound or microwave. In this case the energy delivery is more efficient since energy is delivered to a solution volume rather than a solution surface.

After the diol termination is complete the solution is ready to be trifunctionalized through the addition of a low molecular weight triol. Alternatively, the first termination may have been of a polymeric triol, in which case the solution is already trifunctionalized, and addition of a low MW triol may be unnecessary.

If required, the solution is cooled to 20° C. and the triol is added. The temperature is slowly increased using, for example, the following schedule.
20° C. for 5% of the total reaction time
25° C. for 5% of the total reaction time
30° C. for 5% of the total reaction time
35° C. for 5% of the total reaction time
40° C. for 5% of the total reaction time
45° C. for 5% of the total reaction time
50° C. for 5% of the total reaction time
70° C. for 15% of the total reaction time
80° C. for 50% of the total reaction time

The final temperature can be adjusted in the range of between 60° C. and 150° C.

Preferred Compositions

For slow reactions, as are often desirable in tissue filling and bulking, IDPI or another slow reacting diisocyanate is preferred both as polymer-terminating isocyanate and the free isocyanate. For reactions in which the polyurethane should adhere firmly to tissue, and/or be made rapidly, TDI or another fast-reacting isocyanate is the preferred free isocyanate, and preferably also as the terminal isocyanate.

Preferred tissue filling-type compositions are the product of reacting about 20% by weight to about 40% by weight IPDI, 65% by weight to about 85% by weight diol and about 1% by weight to about 10% by weight TMP. More preferably, the composition is the product of reacting in weight ratios about 25% to about 35% IPDI, 70% to about 80% diol and about 2% to about 8% TMP. Most preferably, the composition is the result of reacting about 25% to about 30% IPDI, about 70% to about 75% diol and about 1% to about 8% TMP. Most preferably, the composition is the result of reacting about 25% IPDI, 70% diol and about 1% to 2% TMP. In a preferable alternative, a polymeric triol is supplied, and In all of the above reaction products, the preferred diol is a polymer having in the range of about 70-80% ethylene glycol monomers and 20-30% propylene glycol monomers, more preferably about 75% ethylene glycol and 25% propylene glycol monomers.

Preferred tissue adhesive-type compositions are the product of reacting about 20% by weight to about 40% by weight TDI, 65% by weight to about 85% by weight diol and about 0.5% by weight to about 2% by weight TMP. More preferably, the composition is the product of reacting in weight ratios about 20% to about 25% TDI, 70% to about 80% diol and about 0.7% to about 1.2% TMP. Most preferably, the composition is the result of reacting about 23% to about 25% TDI, about 73% to about 77% diol and about 0.7% to about 1.0% TMP. Most preferably, the composition is the result of reacting about 24% TDI, 75% diol and about 0.7% to 1.0% TMP. In all of the above reaction products, the preferred diol is a polymer having in the range of about 70-80% ethylene glycol monomers and 20-30% propylene glycol monomers, more preferably about 75% ethylene glycol and 25% propylene glycol monomers. In any of the above preparations, the diol and TMP can be replaced with a polymeric triol or higher functionality, such as a polyalkylene oxide initiated by a trifunctional or higher polyfunctional initiator, such as TMP or similar material. The amount of TDI, IPDI or other free isocyanate would be reduced, so that just enough is provided to end-cap all of thevpolymeric triol and any diol present, and to leave a small percentage of free isocyanate at the end of the reaction.

In use, the cure time and cured modulus can be altered by premixing the pre-polymer with saline prior to application. In the case of tissue filling compositions, premixing the prepolymer with from about 80% to about 20% saline on a volume basis is preferred. In the case of an adhesive composition, it is preferred to mix the prepolymer with from about 1% to about 50% saline on a volume basis to adjust cure time and cured modulus to desired properties. In the case of an adhesive composition, premixing the prepolymer with about 50% saline results in a cure time of about 60 seconds, which is believed to be suitable for most surgical applications.

In the examples provided below, some are prepolymers applied directly to tissue and others are to be mixed with water before application to tissue. The addition or existence of water at the application site makes the chain extension step a competing reaction.

The first two examples represent variations that can be applied to all of the examples in order to prepare tissue adhesives with stronger cohesive vs. adhesive strength. In all examples the diols and triols have been deionized and dried as described above, and may be stored in sealed glass containers under inert atmosphere such as argon.

In the examples described below, reference to cure time means the time after initial mixing at which a solution of prepolymer and water can no longer be passed between connected syringes under 5 lbs. of hand pressure applied to the syringe plunger.

### EXAMPLE 1

In this example an isocyanate terminated diol is trifunctionalized to yield a slow curing tissue adhesive. The type and amount of isocyanate to be used is 326.27 g of isophorone diisocyanate (IPDI). A suitable IPDI was Desmodur I. The type and amount of diol to be used is 749.94 g of 75:25 diol comprised of 75% polyethylene glycol and 25% polypropylene glycol. A suitable diol is Ucon 75-H-450, with a molecular weight of 978 Daltons and hydroxyl number of 119.4. The type and amount of triol to be used is 23.79 g of trimethylol propane. The theoretical target for completion of the diol termination steps is % NCO=5.23%. The theoretical target for completion of the trifunctionalization step is % NCO=3.09%. Final temperature pre-TMP is 80° C. The NCO levels at various times are: at 28 hrs 6.197%, at 56 hrs 5.468%, at 78 hrs 5.421, and at 126 hrs 5.23%. The TMP is added at hour 127. The final % NCO=3.09% is reached at hour 271. The viscosity at 34° C. is 103 Kcps.

The TMP and glycols are deionized and dried using the procedures described above. All of the diol and isocyanate are to be added at once. The temperature in the reacting chamber follows the schedules described above, and the % NCO at the described time points should follow the values recorded above. The reaction should be conducted under vacuum with a trickle flow of argon.

The reactor is a standard cylindrical glass 1 Liter reactor with a stir rod comprising 2 reactor blades of 55 mm diameter with 5 blades oriented 45 degrees from the axis. The rate of mixing is 220 rpm.

Under these conditions the prepolymer is comprised of a broad distribution of chain lengths in the diol termination phase with a minimum of side reactions. This distribution cannot be achieved solely by adding diols of molecular weights in the ratio obtained in the final synthesis product, since the actual synthesis process is critical to the final chain length distribution. Adding the diols in this ratio at the beginning of the synthesis process results in a prepolymer that is unusable as a tissue adhesive. Calling the single chain length of 978 Dalton the monomer, the following distribution is obtained after the diol termination process.

| | Actual Value |
|---|---|
| Monomer | 28.2% +/− 10% |
| Dimer | 20.0% +/− 10% |
| Trimer | 14.8% +/− 5% |
| Tetramer | 10.9% +/− 2% |
| Pentamer | 9.9% +/− 1% |
| Hexamer | 6.8% +/− 1% |
| Heptamer | 5.2% +/− 1% |
| Octamer | 3.3% +/− 1% |
| Nonamer | 1.8% +/− 0.5% |

This distribution is suitable as a space-filling adhesive of high cohesive strength. Prepolymers constructed with a distribution of higher functional species may be employed as a urethral bulker for the treatment of incontinence, lower esophageal bulker for the treatment of gastroesophageal reflux disease, and disc nucleus replacement for the treatment of degenerative disc disease.

### EXAMPLE 2

The experiment performed in Example 1 is modeled, except that the diol is added in 1% increments rather than all at once to the isocyanate. Each 1% increment of diol added to the reacting isocyanate is assumed to be made after the exotherm of the previous addition is complete. This step-wise addition would yield, by calculation, the following distribution of terminated diols:

| | Actual Value |
|---|---|
| Monomer | 55.3% |
| Dimer | 27.1% |
| Trimer | 8.5% |
| Tetramer | 4.7% |
| Pentamer | 2.5% |
| Hexamer | 1.3% |
| Heptamer | 0.6% |

This distribution is believed to be suitable as a tissue adhesive of high adhesive strength.

### EXAMPLE 3

In this example, an isocyanate-terminated diol is trifunctionalized to yield a fast curing tissue adhesive. Fast adhesives cure within 5 minutes when used neat and applied to tissue. Slow adhesives cure after this time, generally 5 to 10 times longer. The type and amount of isocyanate to be used is 270.26 g of toluene diisocyanate (TDI). A suitable TDI is Rubinate, a mixture of 80% 24 and 20% 2-6 isomers. The type and amount of diol to be used is 870.53 g of Ucon 75-H450. The type and amount of triol to be used is 9.21 g of trimethylol propane (TMP). The theoretical target for completion of the diol termination steps is % NCO=4.55%. The theoretical target for completion of the trifunctionalization step is % NCO=3.76%. Final temperature pre-TMP was 50° C. The NCO levels at 25 hrs 4.78% and at 75 hrs 4.55%. Then the TMP was added at hour 76. The final NCO of % NCO=3.67% was reach at hour 100. The viscosity at 31° C. was 24.5 Kcps. The above tissue adhesive forms a tissue bond of strength 4 lb/in² in tension and about 25 lb/in² in shear.

### EXAMPLE 4

In this example, an isocyanate-terminated diol is trifunctionalized to yield a fast curing tissue adhesive with a ratio of soft-to-hard centers greater than that achieved in Example 3. The type and amount of isocyanate to be used is 231.65 g of toluene diisocyanate (TDI). The type and amount of diol to be used is 870.53 g of Ucon 75-H450. The type and amount of triol to be used is 9.21 g of trimethylol propane. The theoretical target for completion of the diol termination steps is % NCO=3.90%. The theoretical target for completion of the trifunctionalization step is % NCO=2.69%. Final temperature pre-TMP was 50° C. The NCO levels at 23 hrs 3.80% and at 75 hrs 4.55%. Then the TMP was added at hour 23. The final NCO of % NCO=2.69% was reach at hour 72. The viscosity at 30° C. was 48 Kcps.

### EXAMPLE 5

In this example, two isocyanate-terminated diols are randomly trifunctionalized to yield a fast curing, absorbable tissue adhesive. The type and amount of isocyanate to be used is 270.26 g of toluene diisocyanate (TDI). The types and amounts of diol to be used are 870.53 g of Ucon 75-H-450 and 25 g poly(DL-lactide-co-glycolide) (50:50). The average molecular weight of the copolymer is 50,000 Dalton. The type and amount of triol to be used is 9.21 g of trimethylol propane. The theoretical target for completion of the diol termination steps is % NCO=4.55%. The theoretical target for completion of the trifunctionalization step is % NCO=3.00%. Final temperature pre-TMP was 50° C. The NCO levels at 96 hrs 4.99% and at 312 hrs 4.41%. Then the TMP was added at hour 312. The final NCO of % NCO=2.93% was reach at hour 528. The viscosity at 32° C. was 240 Kcps.

### EXAMPLE 6

In this example a high molecular weight diol is terminated and randomly trifunctionalized to yield a slow curing, low viscosity tissue adhesive. The type and amount of isocyanate to be used is 171.29 g of isophorone diisocyanate (IPDI). The type and amount of diol to be used is 824.93 g of Ucon 75-H-1400. The molecular weight of 75-H-1400 is 2500 Dalton. The type and amount of triol to be used is 12.49 g of trimethylol propane. The theoretical target for completion of the diol termination steps is % NCO=3.3%. The theoretical target for completion of the trifunctionalization step is % NCO=2.2%. Final temperature pre-TMP was 80° C. The NCO levels at 168 hrs 4.54% and at 624 hrs 3.32%. Then the TMP was added at hour 625. The final NCO of % NCO=2.2% was reach at hour 824. The viscosity at 32° C. was 150 Kcps.

### EXAMPLE 7

In this example, a high molecular weight diol is terminated and randomly trifunctionalized to yield a fast curing, low viscosity tissue adhesive. The formula for Example 6 is used substituting molar equivalents of TDI.

### EXAMPLE 8

### Not Performed

Any of the adhesives of Examples 1-7 is made, but the triol, TMP, is substituted with a molar equivalent of TONE polyol 0301 manufactured by Union Carbide. The molecular weight of this triol is 300 Dalton with a hydroxyl number of 560.

### EXAMPLE 9

In some medical applications, a tissue-bonding adhesive that does not appreciably swell during polymerization is useful. Applications include disc nucleus replacement, disc annulus augmentation, and any application where large static forces predominate. For these applications an adhesive of low % NCO is preferred. It is also advantageous to initiate polymerization outside the body by pre-mixing the tissue adhesive with water. The amount of water added determines cure time and cured modulus. A useful adhesive for these applications can be prepared by mixing the material of Example 7 in the following ratios with water:

| % Prepolymer | % water | cure time | Modulus | |
|---|---|---|---|---|
| 33 | 67 | 1 minute | disc nucleus like | 1-2 N/cm² |
| 50 | 50 | 2 minutes | disc annulus like | 2-3 N/cm² |
| 70 | 30 | 3 minutes | hardest | 3-4 N/cm² |

### EXAMPLE 10

The cured modulus of an adhesive can be increased by adding a particulate. If, for example, 0.3 micron tantalum powder were added to an adhesive, the material can be made radio-opaque. Moreover, a higher modulus disc nucleus replacement can be made by adding 10% by volume tantalum powder to the mixtures of Example 9.

### EXAMPLE 11

In some medical applications, a tissue-bonding adhesive that cures slowly is useful. Applications include augmentation of the lower esophageal sphincter in treatment for GERD, augmentation of the bladder neck in treatment for urinary incontinence, and any application where tissue volume is to be augmented. For these applications an adhesive employing a less reactive isocyanate is preferred. It is also advantageous to initiate polymerization outside the body by pre-mixing the tissue adhesive with saline. The amount of water added determines cure time and cured modulus. A useful tissue filling adhesive composition for these applications can be prepared by mixing Example 6 in the following ratios with water.

| % prepolymer | % water | cure time | Modulus |
|---|---|---|---|
| 20 | 80 | 60 minutes | 0.1 N/cm² |
| 33 | 67 | 50 minutes | 0.2-0.5 N/cm² |
| 50 | 50 | 45 minutes | 0.5-1.0 N/cm² |

The following data demonstrate that short-term volume changes are not of sufficient magnitude to cause leakage of implanted material or bleb rupture when injected into tissue before polymerization.

Swell of Example 6 when measured 25 Minutes After Mixing

| % prepolymer to | | |
|---|---|---|
| Saline (v/v) | Start Volume | % Change |
| 33% | 10.0 cc | +7.3 +/− 1.6% |
| | | (5-10%) |
| 20% | 10.0 cc | +4.1 +/− 1.9% |
| | | (1-8%) |

### EXAMPLE 12

In some medical applications, it is advantageous for the tissue adhesive to cure with a relatively high ultimate elongation. The material of Example 4 mixed in a 50:50 volumetric ratio with saline provides good tissue bonding and ultimate elongations of 300-700%. Such a preparation is useful in certain disc, lung, and vaginal repairs where high strain is expected and the adhesive is meant to replace a mesh or prosthetic.

### EXAMPLE 13

### Not Performed

In any material of the above examples, the more active NCO group on the diisocyanate can be blocked prior to addition to the diol. This condition is achieved by reacting 1 equivalent of NCO with 0.5 eq. of a mono-functional blocking agent, such as an alcohol at low temperature (about 15° C.). Then the one-side-blocked isocyanate, now effectively a monoisocyanate is reacted with the diol to terminate the diols with effectively no chain extension, where the monomer content is greater than 99%. Then the isocyanate functionality is unblocked by heating and evaporation of the blocker. Then the terminated diols are reacted with triol as prescribed.

Prepolymer prepared in this way has a lower viscosity, lower and narrower molecular weight distribution, more aggressive reactivity and shorter cure time than prepolymer prepared using the same starting ingredients without a blocking step. Consequently, when combinations of isocyanates and diols result in consumption of the most active NCO group on the isocyanate during the diol termination procedure, blocking and then exposing this group after diol termination results in a prepolymer with improved bonding with respect to speed of curing and bond strength. Reducing the viscosity of the prepolymer results in improved tissue contact and faster cures. A narrow molecular weight allows for a more accurate match between clinical application and prepolymer characteristics.

### EXAMPLE 14

Versions of the materials of Example 4 and 6 were mixed with saline to demonstrate that the reactivity of the polymerization chemistry is less than 1% at 24 hrs. post-cure.

### NCO Content Comparing Pre- and Post Cured States

| | % Test Article to | | | |
|---|---|---|---|---|
| Test Article | Saline | % NCO +/− SD | # Blanks | # Tests |
| Example 6 | No saline | +1.398 +/− 0.024 | 2 | 5 |
| Pre-Cure | | | | |
| Example 6 | 20% | +0.001 +/− 0.009 | 10 | 10 |
| Post-Cure | | | | |
| Example 4 | No saline | +2.972 +/− 0.053 | 3 | 9 |
| Pre-Cure | | | | |
| Example 4 | 20% | +0.002 +/− 0.006 | 10 | 10 |
| Post-Cure | | | | |

### EXAMPLE 15

The aliphatic (Example 6) and aromatic (Example 4) compositions were tested against a commercially available cyanoacrylate for tissue bonding stability after gamma radiation. The compositions were tested for yield point when stressed in shear. The test configuration consisted of a standardized piece of fresh bovine tissue, a sham attachment and a test bond. Stress was developed between the sham attachment and the test bond. The sham attachment was designed to ensure the test bond fails first. The requirement for yield point acceptance was that the slope of the stress-strain plot be discontinuous at the point of break.

Bond strengths were assessed as a function of Gamma radiation dose in the following tests:
Test I: an aliphatic composition (Example 6
Test II: an aromatic composition (Example 4
Test III: a cyanoacrylate (VetBond
Test IV: albumin based adhesive

### Tissue Bond Strength in Shear Post-Irradiation (N=10 per Dose/Duration data point)

| Dose | Test I | Test II | Test III | Test IV |
|---|---|---|---|---|
| 0 kgy | 23.2 +/− 0.3 lbs/sqin | 25.1 +/− 0.5 lbs/sqin | 30.7 +/− 1.2 lbs/sqin | 5.8 +/− 1.6 lbs/sqin |
| 30 kgy | 22.7 +/− 0.3 lbs/sqin | 24.5 +/− 0.5 lbs/sqin | 22.8 +/− 0.4 lbs/sqin | 4.9 +/− 1.5 lbs/sqin |
| 40 kgy | 22.5 +/− 0.2 lbs/sqin | 25.5 +/− 0.4 lbs/sqin | 18.5 +/− 0.7 lbs/sqin | 4.5 +/− 1.2 lbs/sqin |
| 50 kgy | 22.8 +/− 0.4 lbs/sqin | 25.3 +/− 0.5 lbs/sqin | 11.4 +/− 1.9 lbs/sqin | 3.9 +/− 2.4 lbs/sqin |

### EXAMPLE 16

The viscosity of Example 6 was measured before mixing with saline and after to ensure it can be injected through a 23G needle.

Measured viscosities:

| | |
|---|---|
| Example 6 at room temperature: | 20% |
| Example 6 & 80% saline: | 67 +/− 2 cps (25° C.) |
| 25% Example 6 & 75% saline: | 98 +/− 1 cps (25° C.) |
| Example 6 alone: | 79,100 +/− 2,400 cps (25° C.) |

### EXAMPLE 17

The effect of pH on cure time of Example 4 and Example 6 was measured at room temperature (25° C.). Time to cure is measured by passing implant mixture between two connected syringes until mixing can no longer occur due to polymerization. The saline to prepolymer ration was 50:50 (v/v).

Results:

### Cure Time at Varied pH

| Test Article | pH = 4 | | pH = 6 | | pH = 8 | |
|---|---|---|---|---|---|---|
| Example 6 | 1360 +/− 61 | sec | 1292 +/− 42 | sec | 1275 +/− 49 | sec |
| | 1288-1430 | sec | 1237-1362 | sec | 1205-1357 | sec |
| Example 4 | 39 +/− 2 | sec | 34 +/− 2 | sec | 34 +/− 1 | sec |
| | 36-40 | sec | 32-37 | sec | 32-36 | sec |

### EXAMPLE 18

The effect of temperature on cure time of Example 4 and Example 6 was measured. Time to cure is measured by passing implant mixture between two connected syringes until mixing can no longer occur due to polymerization.

Cure Time at Various Temperatures

| Cure Time of Test Article | 22° C. | | 32° C. | | 42° C. | |
|---|---|---|---|---|---|---|
| Cure Time of 20% Example 6 and 80% | 1743 +/− 65 | sec. | 1101 +/− 22 | sec. | 672 +/− 34 | sec. |
| 0.9% saline | 1651-1854 | sec. | 1062-1125 | sec. | 615-707 | sec. |
| Cure Time of 67% Example 4 and 33% | 89 +/− 5 | sec. | 61 +/− 3 | sec. | 47 +/− 3 | sec. |
| 0.9% saline | 81-94 | sec. | 58-65 | sec. | 42-52 | sec. |

### EXAMPLE 19

The avoidance of side reactions is important in achieving a long shelf life. We demonstrate effect of shelf life on gamma radiated material (25 kgy).

### % NCO of Packaged, Sterilized Test Article (>25 kgy, N=10 Each) at Accelerated Times

| Test Article | Fresh | 3 months | 6 months | 12 months | 18 months |
|---|---|---|---|---|---|
| Example 6 | 1.48 +/− 0.07 | 1.25 +/− 0.09 | 1.26 +/− 0.16 | 1.29 +/− 0.12 | 1.46 +/− 0.32 |
| | 1.38-1.58 | 1.03-1.29 | 1.03-1.45 | 1.13-1.48 | 0.93-1.97 |
| Example 4 | 3.02 +/− 0.06 | 3.03 +/− 0.06 | 3.05 +/− 0.15 | 2.75 +/− 0.03 | 2.57 +/− 0.25 |
| | 2.94-3.12 | 3.17-3.31 | 2.87-3.21 | 2.70-2.80 | 2.26-2.97 |

### EXAMPLE 20

When mixing prepolymer with saline, it is important to achieve a long duration during which the viscosity of the solution does not change appreciably, followed by a rapid transition to polymerization. This condition is achieved by the above methods of drying, deionizing, and controlling the exotherm of the synthesis process.

### Room Temperature 22° C.+/−2° C. Work Time, Transition Time for Saline Solutions of Test Article.

| Test Article | % | Work Time* | | Transition Time** | |
|---|---|---|---|---|---|
| Example 6 | 20% | 24 +/− 1 | min. | 3 +/− 0 | min. |
| | | 23-26 | min. | 3-4 | min. |
| Example 4 | 33% | 42 +/− 1 | sec. | 2 +/− 1 | sec. |
| | | 41-43 | sec. | 1-3 | sec. |

### EXAMPLE 21

We studied the biocompatibility of Example 6 as a representative composition.

| Memorandum G95-1 | | | | | Test |
|---|---|---|---|---|---|
| Recommendations | Test Facility | Standard/Method | Model | Extract | Result |
| Cytotoxicity | MTL | ISO 10993-5 | L-929 Mouse | MEM Eluate/37° C./24 hrs. | Passed |
| | 2021IL | Elution | Fibroblasts | | |
| Sensitization | MTL | ASTM F720- | Guinea Pig (21) | 0.9% Saline/37° C./72 hrs.. | Passed |
| | | Modified Klingman- | | | |
| | | one extract | | | |
| Intracutaneous | MTL | ISO 10993-10 | Rabbit (3) | 0.9% Saline/37 deg C/72 hrs | Passed |
| Reactivity | 2005I | | | | |
| Pyrogenicity | Associates of | Limulus Amebocyte | | Polymerized SynthaSeal | Passed |
| | Cape Cod, Inc | Lysate (LAL) Test | | | |
| | Sterilization | USP Rabbit Pyrogen | Rabbit (3) | 0.9% Saline/37-40 deg | Passed |
| | Technical | Test | | C/40-60 minutes | |
| | Services for | | | | |
| | MTL | | | | |
| | T00-3163 | | | | |
| Genotoxicity | MTL | Ames Test | Salmonella | 0.9% Saline/50° C./72 hrs | Passed |
| | | (Mutagenesis Test) | typhimurium | | |
| | MTL | Mouse Peripheral | Balb/C Mice | 0.9% Saline/37° C./72 hrs | Passed |
| | 2035C | Blood Micronucleus | (5M/5F) | | |
| | | Assay: Acute | | | |
| | | Exposure | | | |
| | MTL | L-5178T TK +/− Mouse | S9 prepared | 0.9% Saline/37° C./72 hrs | Passed |
| | 2032M | Lymphoma | from adult | | |
| | | Forward Mutation | Sprague- | | |
| | | Assay | Dawley rats | | |
| Implantation | MTL | USP Muscle Implant | Rabbit (3) | 1 mm × 10 mm | Passed |
| | 2006C | 180 Day | | strip of cured test | |
| | | | | article (50% saline, | |
| | | | | 50% SynthaSeal) | |
| Chronic | MTL | 180 Day | Mouse (20) | MEM | Passed |
| Toxicity | 2004C | | | Eluate/37° C./24 hrs, | |
| | | | | twice weekly | |
| | | | | injected for first 3 | |
| | | | | weeks, and weekly | |
| | | | | thereafter (20 ml | |
| | | | | extract/kg-i.v.) | |
| Immunotoxicity | MTL | Hemocompatibility | Normal human | Polymerized | Passed |
| | 2024 | ISO 10993-4 | serum | | |
| | | [Complement | | | |
| | | Activation Assay (in- | | | |
| | | vitro) - Saline Extract | | | |

### EXAMPLE 23

In this example, a method of adjusting the cure time is described. It entails synthesizing a solution containing a fractional amount of end-capped functional units of Type A and the balance of Type B, wherein the cure time of a solution entirely end capped with type A is longer than the cure time of a solution entirely end capped with type B. This end can be achieved in two ways. First, separate solutions of pure Type A and pure Type B can be mechanically mixed. Secondly, the desirable ratio of Type A and Type B can be achieved by beginning with raw materials reflecting the final desired ratio.

Example 1 is a slow curing prepolymer, which cures in approximately 60 minutes at room temperature. Example 3 is a fast curing prepolymer, which cures in approximately 2 minutes at room temperature. A prepolymer that cures in 12 minutes can be obtained by mixing 30% by volume of Example 2 with 70% by volume of Example 1. A prepolymer that cures in 30 minutes can be obtained by mixing 20% by volume of Example 2 with 80% by volume of Example 1. Prepolymers prepared in this way are stable because all the hydroxyl groups in the respective solutions had been terminated with NCO functional groups.

### EXAMPLE 24

A trifunctional polyalkylene oxide was purchased from BASF (1123 Triol). It was nominally a triol, with actual functionality being about 2.75. The molecular weight was nominally 12,000 D, with the core (25% by number) being polypropylene oxide and the rest of the chain being polyethylene oxide units polymerized onto the PPO core. The triol (870 g.) was mixed with 37.84 TG of TDI, calculated to be enough to cap all the polymer chains at trifunctionality. The target NCO content, chain and free, was 0.98%. The material was used to create a spinal disc replacement in situ, with proper strength.

The examples have been presented to aid in the understanding of the invention. However, the invention is not limited in scope by the examples or the description in the specification, but by the following claims.

1. A method for making a tissue-reactive polyurethane prepolymer for surgical use, the method comprising the steps of:
a) drying a macromolecular polyoxyalkylene polyol, which comprises one or more of a polymeric diol, a polymeric triol and a higher functionality polymeric polyol;
b) mixing the polyol with a low molecular weight di-isocyanate compound;
c) controlling the degree of chain extension during the mixing of the polyol with the diisocyanate by one or more of:
i) adding the polyol to the diisocyanate in aliquots, and allowing the reaction to substantially complete before adding a subsequent aliquot;
ii) mixing at least some of the polyol with the diisocyanate at a low temperature, and raising the temperature in one or more sequential steps, allowing carbon dioxide emission to cease before moving to the next temperature step; and
iii) mixing the polyol with excess isocyanate and, after reaction, removing most or all of the excess isocyanate by a separation reaction; and
d) when the polymeric polyol is entirely or predominantly a diol, adding a dried low molecular weight triol or higher polyol to the diisocyanate-tipped diol to make a branched isocyanate preparation capable of crosslinking sufficiently to form a coherent solid.

2. The method of claim 1 wherein an excess of low molecular weight diisocyanate is present in the product at the time of placing the preparation into long term storage.

3. The method of claim 2 wherein the excess is less than about 5% of the active isocyanate groups in the preparation.

4. The method of claim 2 wherein the excess is less than about 2% of the active isocyanate groups in the preparation.

5. The method of claim 1 wherein the preparation is sterilized by gamma radiation.

6. The method of claim 1 wherein the preparation is treated to prevent the formation of, or substantially remove, byproducts of the synthesis reactions that contain biuret, allophane, or isocyanurate byproducts or bonds.

7. The method of claim 6 wherein the treatment is maintenance of a temperature below about 50 degrees C. during the reaction of the polymeric polyol with the free diisocyanate.

8. The method of claim 6 wherein the treatment is treatment of a finished branched preparation at a temperature above about 150 degrees C., followed by a rapid quenching to a temperature below about 50 degrees C.

9. The method of claim 1 wherein the finished branched isocyanate preparation is diluted with a medically acceptable aqueous solution immediately before use.

10. The method of claim 1 wherein the finished branched isocyanate preparation is deionized sufficiently to have a level of ions that is sufficiently low to meet the requirements of the regulatory authorities in the jurisdiction in which it is sold for administration to a human being.

11. The method of claim 1 wherein the polyoxyalkylene polyol has about 30% to about 10% by number of propylene oxide subunits and about 70% to about 90% by number of ethylene oxide subunits.

12. The method of claim 1 wherein the polyoxyalkylene polyol has about 25% by number of propylene oxide subunits and about 75% by number of ethylene oxide subunits.

13. A composition prepared according to the method of claim 1.

14. The composition of claim 13 wherein the tissue-reactive prepolymer is a product of reacting about 20% by weight to about 40% by weight of free isocyanate, 65% by weight to about 85% by weight polyalkyleneoxide diol, and about 1% by weight to about 10% by weight trimethylol propane.

15. The composition of claim 13 wherein the tissue-reactive prepolymer is a product of reacting in weight ratios about 25% to about 35% free isocyanate, 70% to about 80% polyalkyleneoxide diol and about 2% to about 8% TMP.

16. The composition of claim 13 wherein the tissue-reactive prepolymer is a is the product of reacting about 25% to about 30% free isocyanate, about 70% to about 75% polyalkyleneoxide diol and about 1% to about 8% TMP.

17. The composition of claim 13 wherein the tissue-reactive prepolymer is a product of reacting about 20% by weight to about 40% by weight free isocyanate, 65% by weight to about 85% by weight polyalkyleneoxide diol and about 0.5% by weight to about 2% by weight TMP.

18. The composition of claim 13 wherein the free low molecular weight diisocyanate is one or both of TDI and IDPI.

19. The composition of claim 13 wherein the tissue-reactive prepolymer is a product of reacting about 25% IPDI, 70% polyalkyleneoxide diol and about 1% to 2% TMP by weight

20. The composition of claim 13 wherein the tissue-reactive prepolymer is a product of reacting about 23% to about 25% TDI, about 73% to about 77% diol and about 0.7% to about 1.0% TMP.

21. The composition of claim 13 wherein the tissue-reactive prepolymer is a product of reacting in weight ratios about 20% to about 25% TDI, 70% to about 80% diol and about 0.7% to about 1.2% TMP.

22. The composition of claim 13 wherein the tissue-reactive prepolymer is a product of reacting about 24% TDI, 75% diol and about 0.7% to 1.0% TMP.

23. The composition of claim 13 wherein the tissue-reactive prepolymer is a product of reacting about 4% free diisocyanate with about 96% polymeric triol/diol mixture.

24. The composition of claim 13 having a viscosity of less than about 150,000 centipoise at 20 deg. C.

25. The method of claim 1 wherein the prepolymer has a viscosity of less than about 150,000 centipoise at 20 deg. C.

26. The composition of claim 13, further containing sufficient aqueous solution that the aqueous solution constitutes from about 5% to about 80% of the composition as administered to a patient.
